(19) United States
(12) Patent Application Publication
(10) Pub. No.: US 2011/0051977 A1
(43) Pub. Date: Mar. 3, 2011

(54) Ear Canal Microphone

(76) Inventors: David J. Losko, Meadow Vista, CA (US); David M. Lancisi, Folsom, CA (US); William T. Davis, Driftwood, TX (US)

(21) Appl. No.: 12/550,343

(22) Filed: Aug. 28, 2009

(51) Int. Cl. H04R 1/10

(52) U.S. Cl. 381/380

(57) ABSTRACT

An earpiece carrying a microphone and a transmitter is disclosed. The earpiece is adapted to position the microphone within a canal of an ear of a wearer.

### BACKGROUND

Microphones convert mechanical energy from sound into electrical impulses for transmission and subsequent reproduction, processing, or storage. Microphones may be differentiated by method of conversion as well as pickup patterns.

Conversion approaches may rely upon electromagnetic (i.e., dynamic), electrostatic (i.e., static), piezoelectric, or resistive change effects, for example. Microphones are also designed with particular pickup patterns. Some microphones utilize an omnidirectional pickup pattern. Other microphone architectures have a directional pickup pattern. Factors that may be relevant to choosing a particular microphone architecture include price, durability, quality of signal produced, accuracy of reproduction, proximity effect, and frequency response.

For some applications, ambient audio signals may create substantial interference with the desired audio signal thus decreasing the signal-to-noise ratio. One approach to creating a better signal-to-noise ratio is to utilize noise cancellation circuitry. Such circuitry may introduce unwanted cost and may not be effective depending upon the application.

Another approach to creating a better signal-to-noise ratio is to position the microphone closer to the source of the desired audio signal. Such re-positioning may not be feasible, however, depending upon factors such as the microphone architecture or the application.

### SUMMARY

An earpiece carrying a microphone and a transmitter is disclosed. The earpiece is adapted to position the microphone within a canal of an ear of a wearer.

### BRIEF DESCRIPTION OF THE DRAWINGS

FIG. 1 illustrates one embodiment of an ear microphone apparatus.

FIG. 2 illustrates positioning of the ear microphone within the ear canal.

FIG. 3 illustrates an alternative view of the ear microphone of FIG. 1.

FIG. 4 illustrates an alternative view of the ear microphone of FIG. 1.

FIG. 5 illustrates one embodiment of a block diagram of functional components of an ear microphone incorporating a transmitter.

FIG. 6 illustrates one embodiment of an ear microphone including a speaker.

FIG. 7 illustrates one embodiment of a block diagram of functional components of an ear microphone.

FIG. 8 illustrates one embodiment of a block diagram of functional components of an ear microphone incorporating a hybrid.

FIG. 9 illustrates an ear microphone communicating with a mobile phone.

FIG. 10 illustrates a mobile phone communicating with an ear microphone for upstream communications and an external audio amplifier for downstream communications.

FIG. 11 illustrates an ear microphone communicating via one or more relay transceivers to one or more end user transceivers.

FIG. 12 illustrates direct communication between the ear microphone and another ear microphone or other end user device without any intervening relays.

FIG. 13 illustrates ear microphone communicating with another device such as an ear microphone via a single relay.

FIG. 14 illustrates an ear microphone communicating with another device such as an ear microphone via a plurality of relays.

FIG. 15 illustrate an ear microphone communicating with a plurality of other devices such as ear microphones via a relay.

FIG. 16 illustrates an ear microphone communicating with other devices such as ear microphones via different relays.

### DETAILED DESCRIPTION

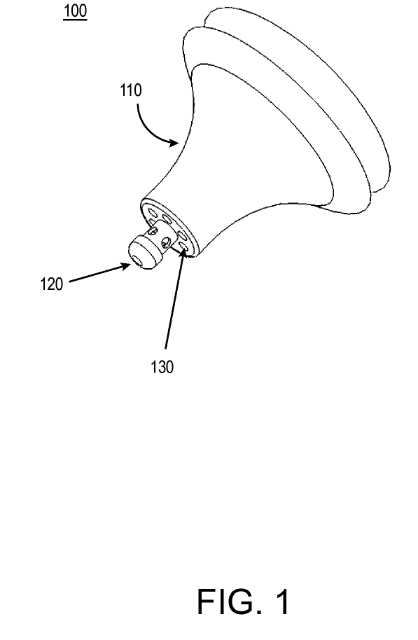

FIG. 1 illustrates one embodiment of an ear canal microphone. In the illustrated embodiment, the ear canal microphone 100 includes an earpiece 110 carrying a microphone 120, and a transmitter (internal to the earpiece). In one embodiment, the earpiece includes air holes 130.

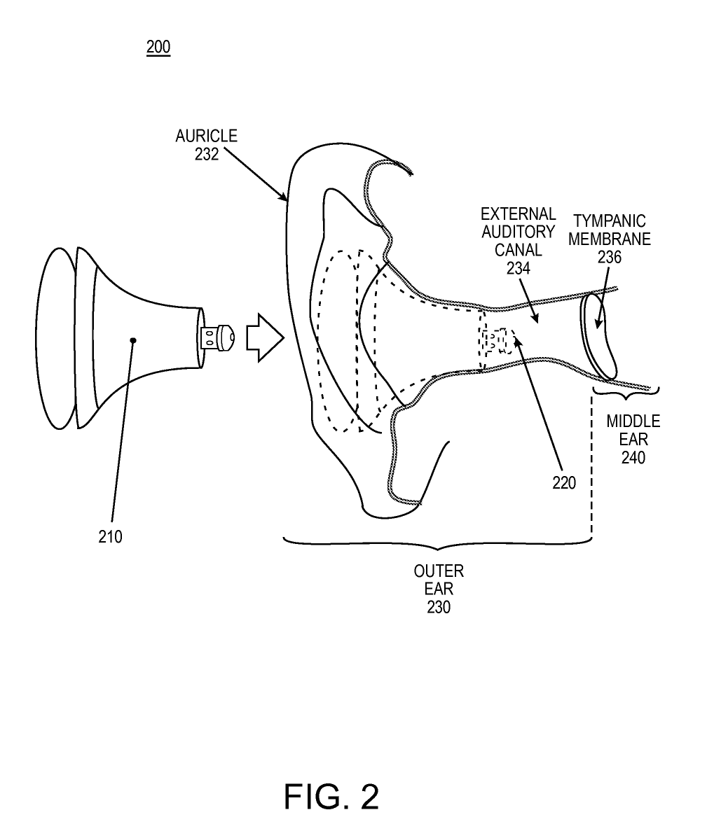

As illustrated in FIG. 2, the earpiece 210 is adapted to position the microphone 220 within the outer ear 230. In particular, the microphone 220 is disposed within the ear canal 234 of a wearer. The ear microphone does not enter the middle ear 240 nor breach the tympanic membrane 236. The microphone 220 is configured to detect sound in the wearer's ear canal and to produce a corresponding electrical audio signal.

The term “audio signal” generally refers to representation of sound waves irrespective of the form of such signal. Examples of such representation may include current, voltage, arrangement of magnetic domains, pulses of light, etc. The term “audio signal” may also be occasionally used to identify original or reproduced sound waves in the form of mechanical sound energy. The form of representation can be determined from the context of the usage of the term. Generally, audio signals represent sound frequencies in a range of approximately 20 Hz to 30 KHz, however, the range may be translated, increased, or decreased depending upon the application and the wearer's hearing ability.

Although this apparatus may be supplemented with hearing aid functionality, the ear canal microphone is distinguished from a hearing aid. A hearing aid utilizes microphones to pickup sound emanating from outside of the ear, and then produces an amplified reproduction of the original sound that is introduced into the ear canal of the wearer. In contrast, the ear microphone picks up sound from within the ear canal for transmission outside the ear.

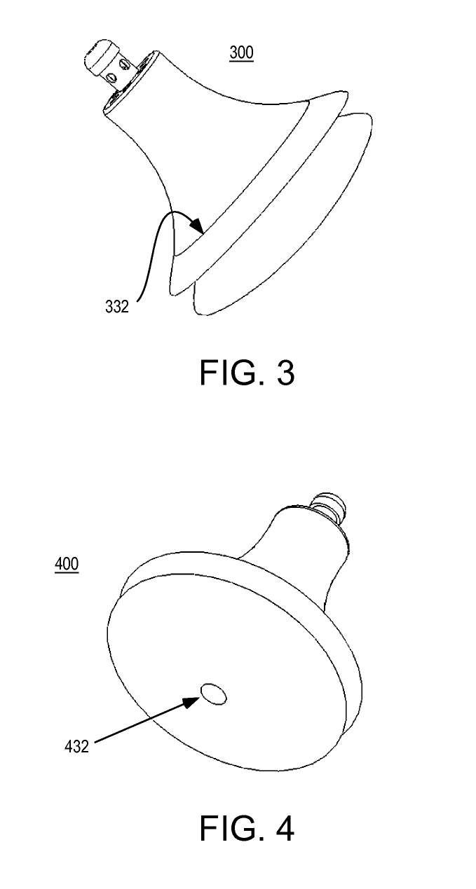

FIG. 3 illustrates an alternative view of the ear microphone 300. FIG. 4 illustrates another view of the ear microphone 400. With reference to FIG. 1, the air holes 130 permit the exchange of air between the ear canal and the interior of the earpiece 110. The earpiece may contain other air holes 432 that permit the exchange of air between the interior of the earpiece and the atmosphere external to the body of the wearer. In one embodiment, the earpiece and the air holes 130, 432 are configured to permit fluid communication between the ear canal and the atmosphere external to the body of the wearer.

The ability to exchange air between the area outside the body of the wearer and the ear canal enables an equalization of pressure for both comfort and to eliminate distortion of the wearer's voice that might otherwise result due to use of the microphone within a plugged ear canal. The lack of such ability can result in the wearer experiencing an undesirable “plugged ear” feeling. The air hole(s) for exchanging air with the atmosphere external to the wearer's body may be located in any number of places or take any form factor. For example, the air hole(s) 332 may be incorporated as one or more vents in discreet locations around the periphery of the earpiece.

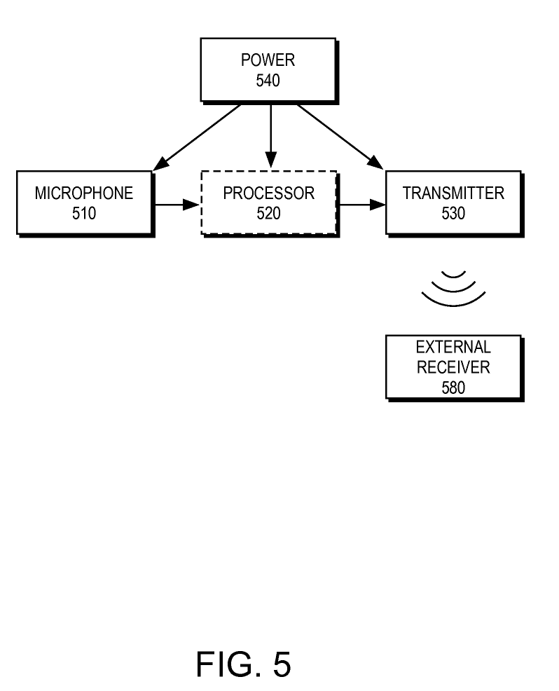

FIG. 5 illustrates one embodiment of a functional block diagram for the ear microphone. The earpiece carries microphone 510, an optional processor 520, a transmitter 530, and a power supply 540. In one embodiment, the microphone signal is provided to the transmitter without substantial modification. In an alternative embodiment, the microphone signal is provided to a processor 520 prior to transmission. Processor 520 may provide codec, noise cancellation, or other signal processing functions. Transmitter 530 communicates the resulting signal to an external receiver 580. External receiver 580 may transmit its received signal to yet another receiver.

Referring to FIGS. 1, 3, and 4, embodiments incorporating air holes such as 130, 332, 432 can permit sound emanating from outside of the ear to pass through the earpiece into the ear canal. Air holes 130 also permit the introduction of sound generated by the earpiece into the ear canal of the wearer, for example, via a speaker carried by the earpiece.

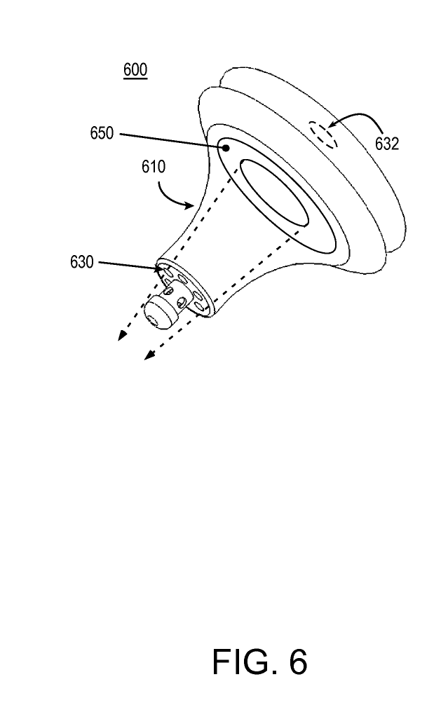

FIG. 6 illustrates one embodiment of the ear microphone 600 including a speaker 650. The speaker is carried by the earpiece 610. The speaker enables reproduction or generation of sound from electrical audio signals. In particular, the speaker converts electrical energy to mechanical energy as sound for introduction into the ear canal through air holes 630. One or more air holes 632 in conjunction with air holes 630 may provide for an exchange of air between the ear canal and the atmosphere external to the wearer's body.

The earpiece may carry amplifier circuitry to support driving the speaker. The audio signal produced by the speaker may originate from locations within listening distance of the wearer's ear, a remote location, or both. In order to support receipt of audio signals from a remote location, the ear microphone may incorporate a receiver.

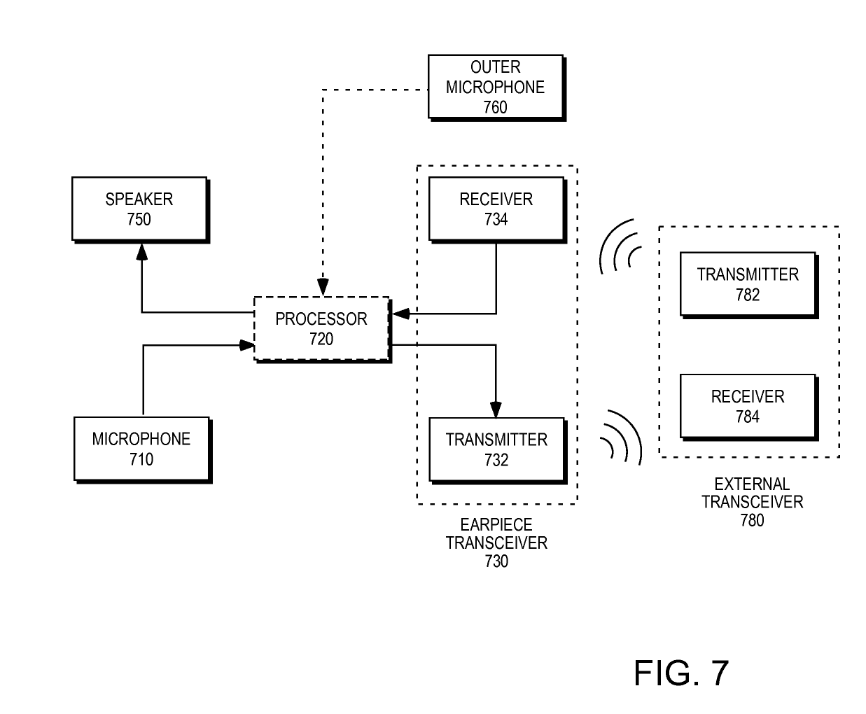

FIG. 7 illustrates one embodiment of a functional block diagram of the ear microphone with a transceiver. The earpiece carries microphone 710, an optional processor 720, a transceiver 730, a power supply (not illustrated), and a speaker 750. The earpiece transceiver includes a transmitter 732 and a receiver 734. The transceiver permits communication with an external transceiver 780 that likewise includes a transmitter 782 and receiver 784.

In one embodiment, the earpiece may also carry an outer microphone 760 positioned to pickup audio signals presented to the auricle of the ear. The signal from such an outer microphone may be useful for purposes of noise cancellation with respect to the signal provided by microphone 710.

The outer microphone signal can also be used to pickup audio signals corresponding to sound incident upon the auricle and to inject such audio signals into the ear canal of the wearer. This may be accomplished via speaker 750 in a controlled fashion. In such a case, the ear canal carries audio signals originating from the wearer as well as audio signals originating from other sources.

In one embodiment, the signal provided by ear microphone 710 is processed by a hybrid serving a function similar to the hybrid circuit found in two-wire telephony applications. The hybrid serves the purpose of extracting the audio signals originating from the wearer from those originating from other sources. The hybrid function may be handled through digital signal processing by a processor such as processor 720.

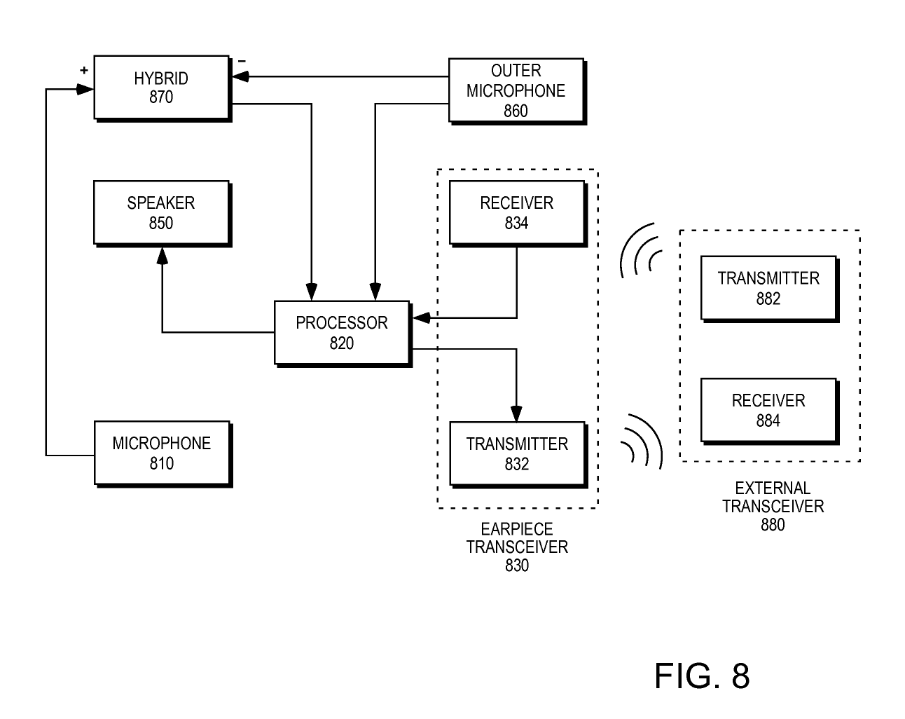

FIG. 8 illustrates an alternative embodiment wherein the hybrid function is performed by a hybrid external to the processor (e.g., hybrid circuit 870). The hybrid circuit receives the microphone signal from microphone 810. The microphone signal is the audio signals representing the sounds carried by the ear canal. Such sounds include sounds originating from the wearer as well as sounds introduced into the ear canal from other external sources.

The hybrid utilizes the signal from the outer microphone 860 to identify or extract the audio signal originating from the wearer. The output of the hybrid can then be processed by an optional processor 820 for communication to the transmitter 832. If the ear microphone includes a receiver 834, the transmitter 832 and receiver 834 form transceiver 830. Transceiver 830 may communicate wirelessly with another transceiver 880 incorporating a transmitter 882 and receiver 884. Although not expressly illustrated, the processor may be communicatively coupled to calibrate, tune, or otherwise adjust the components including outer microphone 860, microphone 810, hybrid 870, and earpiece transceiver 830 including the transmitter 832 and receiver 834.

The ear microphone with receiver may be particularly suited for applications such as “hands-free” mobile telephone operation. Some states have passed laws prohibiting drivers from holding and operating a mobile telephone while driving. Even when such use is not prohibited, the operator may have difficulty positioning the telephone in a manner that avoids extraneous noise. The air from an automobile air conditioner, for example, may blow into the microphone during use.

Although some prior art mobile telephone earpieces might offer hand's free operation, the prior art earpieces utilize an external microphone that is particularly susceptible to noise and often cannot adequately pickup the speaker's voice due to the placement of the microphone. For example, some earpieces have a “boom” microphone in which the microphone is positioned toward the mouth of the operator via an extension referred to as a boom. The boom typically positions the microphone near the cheek of the operator. The earpiece boom microphones are still susceptible to ambient noise such as that due to the blowing of an automotive air conditioner.

In contrast, ambient noise due to wind or blown air can be substantially eliminated with the present ear microphone. The wearer's body serves as a natural filter to eliminate noise external to the body. Moreover, the ear microphone may be communicatively coupled to permit operation with a mobile phone for “hands free” operation.

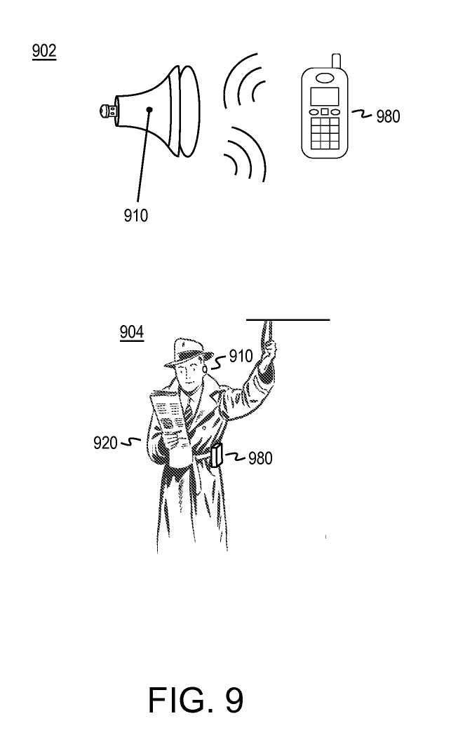

In one embodiment, the ear microphone is used in conjunction with a mobile phone as illustrated in FIG. 9. Voice communications from the user in the form of sound energy are picked up by the ear microphone 910, converted to electrical form, and then transmitted as electromagnetic radiation via the earpiece transmitter to the mobile phone 980 as illustrated in view 902. In one embodiment the earpiece includes a receiver and a speaker such that the earpiece supports two-way voice communications with the communicatively coupled mobile phone. In this embodiment, the earpiece is picking up an converting audio signals for upstream transmission from the ear canal to the mobile phone. Likewise, the earpiece is receiving downstream audio signals from the mobile phone for conversion and introduction into the ear canal via the speaker.

View 904 illustrates one embodiment of a user 920 wearing the ear microphone 910 and mobile phone 980 in a subway. The ear microphone and mobile phone permit “hands-free operation” once a communication link is established. Ambient environmental noise is inherently reduced which makes the ear microphone suitable for environments such as subways, trains, automobiles, stadiums, etc.

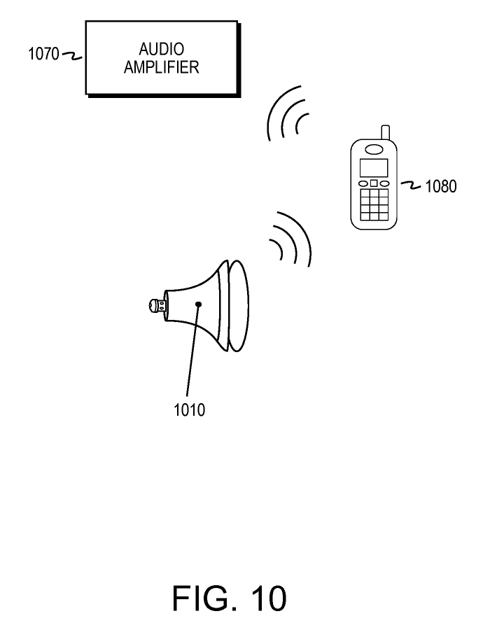

FIG. 10 illustrates another embodiment of the use of the ear microphone 1010 in conjunction with a mobile phone 1080. The mobile phone 1080 is coupled to the earpiece to receive voice communications from the wearer. However, the mobile phone may be linked to an external audio amplifier 1070 to communicate voice communications from the mobile phone to the wearer. The mobile phone thus uses one link such as the link with ear microphone 1010 for “upstream” communications from the user and another link such as the link with external audio amplifier 1070 for “downstream” communications to the user. One example of an external audio amplifier is an automotive stereo system. This approach shifts handling of received communications from the earpiece to another apparatus. This approach offers an opportunity for power savings because circuitry within the earpiece for driving any speaker can be placed into a quiescent state.

The mobile phone in these examples is effectively a relay device for relaying communications to and from the wearer of the earpiece. Alternative embodiments of a relay device may be suited for various embodiments of the earpiece.

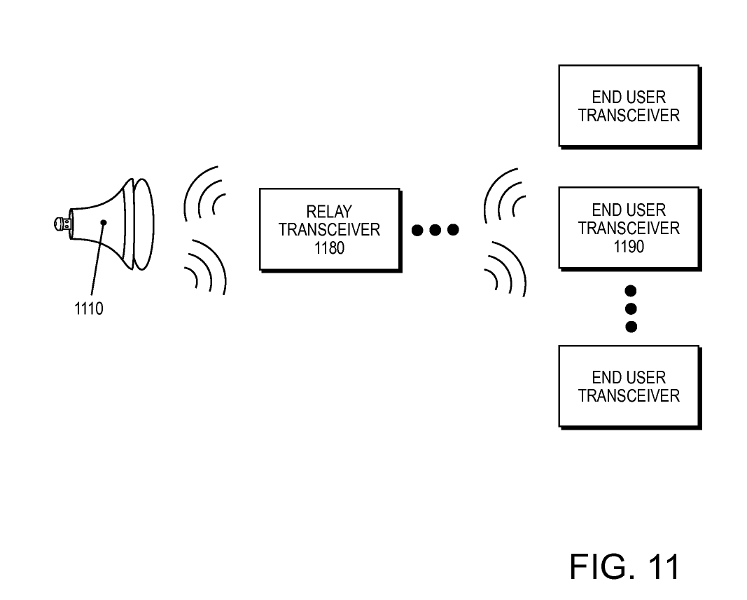

FIG. 11 illustrates the use of an ear microphone in conjunction with one or more relays to communicate with one or more end users. For example, in one embodiment, the ear microphone is communicatively linked with the relay transceiver apparatus 1180. The relay transceiver apparatus may transmit to one or a plurality of other devices including other relay transceivers. In one embodiment, the ear microphone 1110 is used in conjunction with one or more relay transceivers 1180 to communicate with one or more end users 1190.

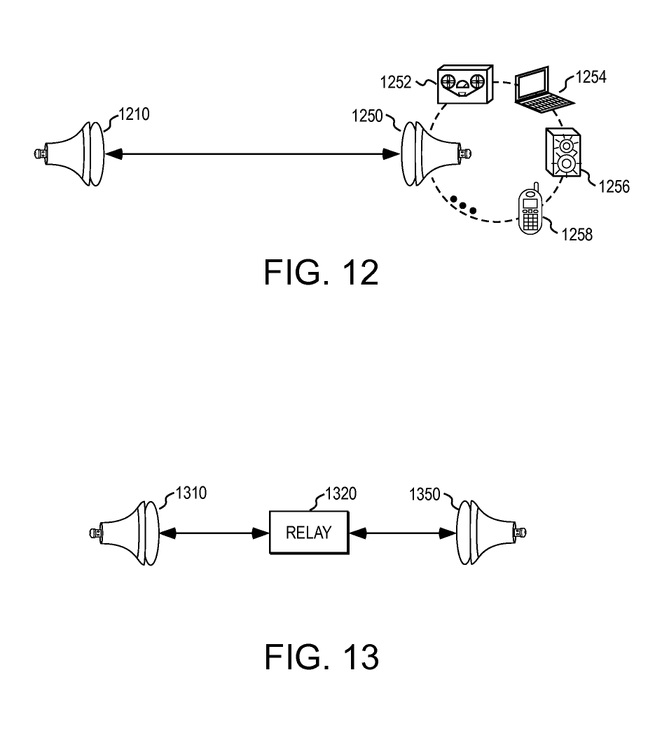

FIGS. 12-16 illustrate various communication network topologies for the ear microphone. FIG. 12 illustrates direct communication between the ear microphone and another ear microphone or other end user device without any intervening relays. Ear microphone 1210 communicates directly with end user device 1250. In various embodiments, the end user device is one of an ear microphone 1250, a recorder 1252, a computer 1254, a speaker 1256, or a mobile phone 1258. In some cases, the end user device or “terminating device” is designed primarily as an output-only device with respect to the ear microphone 1210. Examples of output-only devices include the recorder 1252 and the speaker 1256. In other cases, the end user device handles bi-directional communications with the ear microphone. Such bi-directional devices may include, for example, ear microphone 1250 or the mobile phone 1258.

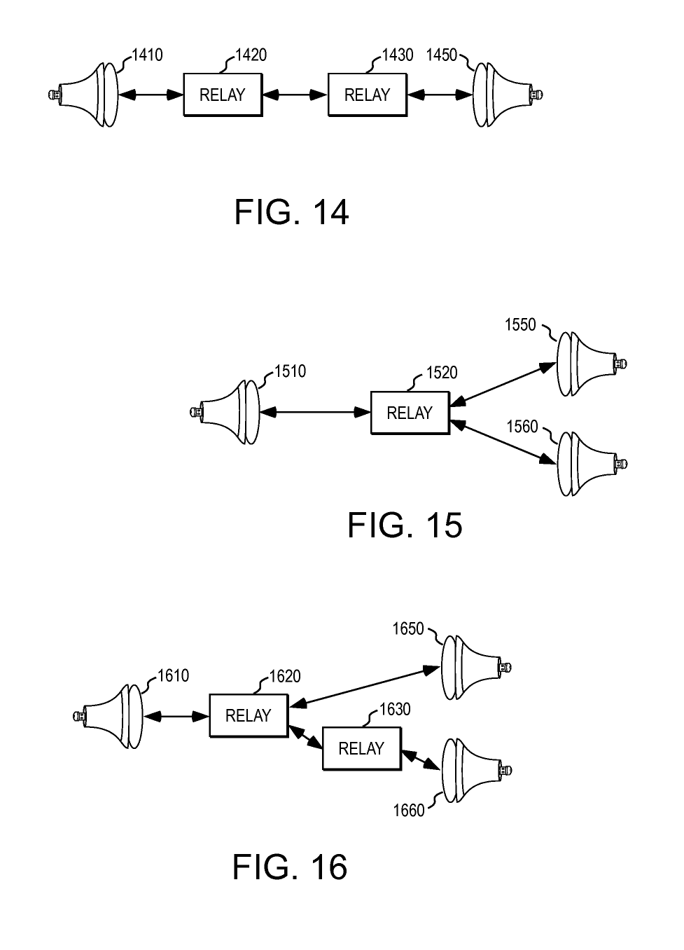

Terminating devices terminates an end or branch of the networked devices. In contrast, a relay is an intervening device between at least two terminating devices and possibly other relays. FIG. 13 illustrates ear microphone 1310 communicating with terminating device 1350 via a single relay 1320. FIG. 14 illustrates ear microphone 1410 communicating with terminating device 1450 via a plurality of relays 1420, 1430. FIG. 15 illustrates ear microphone 1510 communicating with a plurality of terminating devices 1550, 1560 via a common relay 1520.

FIG. 16 illustrates ear microphone 1610 communicating with a plurality of terminating devices 1650, 1660. Communication with terminating device 1650 takes place through relay 1620. Communicating with terminating device 1660 takes place via relays 1620, 1630.

Although communication with the ear microphones is illustrated as a wireless communication for each end user, such illustrations are not intended to preclude wired communications to the relay for at least one end user. For example, the relay may couple the end user to a wireline connection such as that associated with a public switched telephone network system. Thus one or more end users wearing the ear microphone may be communicating with one or more end users via one or more relays that provide wireless communications to some users and wired communications to others. Relay 1320, for example, may provide wired communication to a third end user to support conference calling between the wearers of ear microphones 1310, 1350, and the third end user.

With respect to the wireless transceivers, in one embodiment, the ear microphone transceiver is architected to communicate over a personal area network space of approximately 30 feet or less. The wireless communications may utilize any analog or digital transmission scheme. For example, the ear microphone transceivers may utilize any suitable frequency or frequency band. In one embodiment, the wireless communications take place in a selected frequency band within a range of approximately 300 kHz-11 GHz. In various embodiments, for example, the ear microphone transceivers utilize the AM band, FM band, one of the Industrial Scientific Medical bands (e.g., 915 MHz, 2.45 GHz, 5.8 GHz, etc.), or other band.

Any modulation scheme may include frequency, amplitude, phase, pulse, etc. modulation. The communication between the transceivers and the relay may be linked or linkless. The ear microphone may utilize any wireless communication standard including Bluetooth®, HiperLAN, or UltraWideBand (UWB). In general, any communication protocol suitable for communicating within a personal area network space is a candidate for the ear microphone transceivers (although the ear microphone is not limited to the use of such a communication protocol). Bluetooth® is a certification mark of the Bluetooth Special Interest Group (SIG), Bellevue, Wash., United States which certifies compliance with wireless communication interoperability standards established by the Bluetooth SIG. HiperLAN is a family of communication protocol specifications maintained by the European Telecommunications Standard Institute of Sophia Antipolis, France. Specifications for UWB may be found in IEEE 802.15.4a “Wireless MAC and PHY Specifications for Low Rate Wireless Personal Area Networks (WPAN)”, Institute of Electrical and Electronics Engineers, New York, N.Y., (2007).

Various ear microphone embodiments have been described. Modifications and changes may be made thereto without departing from the broader scope of the invention as set forth in the claims. The specification and drawings are, accordingly, to be regarded in an illustrative rather than a restrictive sense.

What is claimed is:

1. An apparatus comprising:
a microphone;
a transmitter; and
an earpiece carrying the microphone and the transmitter, wherein the earpiece is adapted to position the microphone within an ear canal of a wearer.

2. The apparatus of claim 1 wherein the transmitter communicates audio signals received by the microphone to a terminating device external to the ear.

3. The apparatus of claim 2 wherein the communication between the transmitter and the terminating device is wired.

4. The apparatus of claim 2 wherein the communication between the transmitter and the terminating device is wireless.

5. An apparatus comprising:
a microphone;
a transmitter;
a receiver;
a speaker; and
an earpiece carrying the microphone, transmitter, receiver, and speaker, wherein the earpiece is adapted to position the microphone within an ear canal of a wearer.

6. The apparatus of claim 5 further comprising:
an outer microphone positioned to sense an audio signal external to the wearer, wherein the speaker delivers an audio signal from at least one of the receiver and the outer microphone to the ear canal.

7. The apparatus of claim 6 further comprising:
a hybrid carried by the earpiece, wherein the hybrid combines the audio signals from the microphone and the outer microphone to identify an audio signal originating from the wearer.

8. The apparatus of claim 5 wherein the transmitter wirelessly communicates an upstream audio signal from the ear canal to a terminating device.

9. The apparatus of claim 5 wherein the transmitter wirelessly communicates an upstream audio signal from the ear canal to a relay, wherein the receiver wirelessly receives a downstream audio signal, wherein the speaker delivers the downstream audio signal to the ear canal.

10. The apparatus of claim 5 wherein the transmitter wirelessly communicates an upstream audio signal from the ear canal to a relay, wherein the relay communicates a downstream audio signal to an audio amplifier external to the earpiece.

11. The apparatus of claim 10 wherein the audio amplifier is an automotive stereo system.

12. The apparatus of claim 5 further comprising:
an outer microphone positioned to sense an audio signal external to the wearer, wherein the speaker delivers an audio signal from at least one of the receiver and the outer microphone to the ear canal; and
a processor, wherein the processor combines the audio signals from the microphone and the outer microphone to identify an upstream audio signal originating from the wearer, wherein the outer microphone and processor are carried by the earpiece.
